(19) United States
(12) Patent Application Publication
(10) Pub. No.: US 2006/0070858 A1
(43) Pub. Date: Apr. 6, 2006

(54) Sealing devices for center flow perforated plate filter

(75) Inventors: Cornelius S. de Swardt, Houston, TX (US); Jeremy R. Colvin, Houston, TX (US); Gerald Seidl, Houston, TX (US)

Correspondence Address: James E. Bradley, P.O. Box 61389, Houston, TX, 77208-1389, US

(73) Assignee: Headworks, Inc.

(21) Appl. No.: 11/241,057

(22) Filed: Sep. 30, 2005

Related U.S. Application Data
(60) Provisional application No. 60/614,646, filed on Sep. 30, 2004.

(51) Int. Cl. B65G 49/00

(52) U.S. Cl. 198/803.2

(57) ABSTRACT

A waste water filter has a pair of driven chains carried by the frame and extending in a loop. Screen segments are located between the chains, each of the segments having apertures for the passage of fluid and a shelf portion to lift debris. End plates are secured to opposite ends of each of the segments and seal plates are located between the end plates and the chains. Fasteners secure the end plates and seal plates to the chains. Each of the segments has a first edge that overlaps an upstream side of a second edge of an adjacent segment.

### FIELD OF THE INVENTION

This invention relates in general to wastewater filtration equipment, and in particular to sealing mechanisms for a center flow perforated plate filter.

### BACKGROUND OF THE INVENTION

Large filtration units are used by municipalities and various industries to filter material from the water. One type of filter uses a perforated conveyor having a large number of apertures. The conveyor is rotated in an oblong loop as the water flows through the conveyor. The conveyor is made up of a number of segments pivotally linked to each other. Each segment has a shelf portion that lifts filtered material trapped by the conveyor.

One type of unit is oriented normal to the direction of flow. The water flows through the upward moving run of the conveyor, then the downward moving run. Another type of unit, referred to herein as a center-flow unit, is oriented with the upward and downward moving runs in planes parallel with the direction of flow. The water enters an inlet between upward and downward moving runs and flows out both runs simultaneously.

In both types, chains are located on opposite ends of the segments to drive the conveyor. A variety of devices are employed to connect the segments to the chains. Different types of seal members are used to block fluid flow outward past the ends of the segments. In one type that orients normal to the flow, the unit has end plates mounted to each segment, each end plate being rigidly fastened to one of the links of the chain. That unit also has a seal plate mounted to each end plate. In that unit, the leading and trailing edges of each end plate are parallel with each other. The edges of adjacent end plates are close together on the linear portions of the conveyor and separate at the curved portions. The seal plate has a portion that overlaps an adjacent end plate to block a portion of the gap created at the curved portions. The seal plates have concave and convex edges that slidingly engage each other. While workable for a normal-to-flow filter, a conveyor with end plates and seal plates as described would not work with a center flow type filter.

### SUMMARY

In this invention, the filter has screen segments located between and secured to the chains for movement in unison. Each of the segments has apertures for the passage of fluid and a shelf portion to lift debris. Each of the segments has first and second edges, wherein the first edge of each of the segments overlies and is biased against the second edge of an adjacent one of the segments to prevent leakage between the segments.

End plates are fastened to ends of the segments. Seal plates are located between the end plates and the chains. Fasteners extend through the chain links, seal plates and end plates to secure the segments to the chains. The seal plates have convex and concave opposite ends for sealing engagement with adjacent seal plates.

In the preferred embodiment, the first edge is flat and free to flex slightly relative to the end plates. The second edge is curved and preferably comprises a cylindrical rod or tube. The first edge is the leading edge in the embodiment shown and it contacts the upstream side of the second edge.

### BRIEF DESCRIPTION OF THE DRAWINGS

FIG. 1 is an isometric view of a center flow perforated plate filter constructed in accordance with this invention with the inlet side panel removed.

FIG. 2 is a horizontal sectional view of the filter of FIG. 1, taken along the line 2-2 of FIG. 1.

FIG. 3 is a vertical partial sectional view of the filter of FIG. 1, taken along the line 3-3 of FIG. 2.

FIG. 4 is an enlarged partial sectional view of the filter of FIG. 1, taken along the line 4-4 of FIG. 2.

FIG. 5 is an isometric view of one of the screen segment assemblies for the filter of FIG. 1, shown removed from the filter.

FIG. 6 is a partial isometric view of part of one of the chains of the filter of FIG. 1, as seen from the outside of the filter.

FIG. 7 is an enlarged elevational view of two of the seals of the segment assembly of FIG. 5, shown separated from the chain and the perforated segment.

FIG. 8 is an enlarged partial horizontal sectional view of one of the chains and its associated components of the filter of FIG. 1.

### DETAILED DESCRIPTION OF THE INVENTION

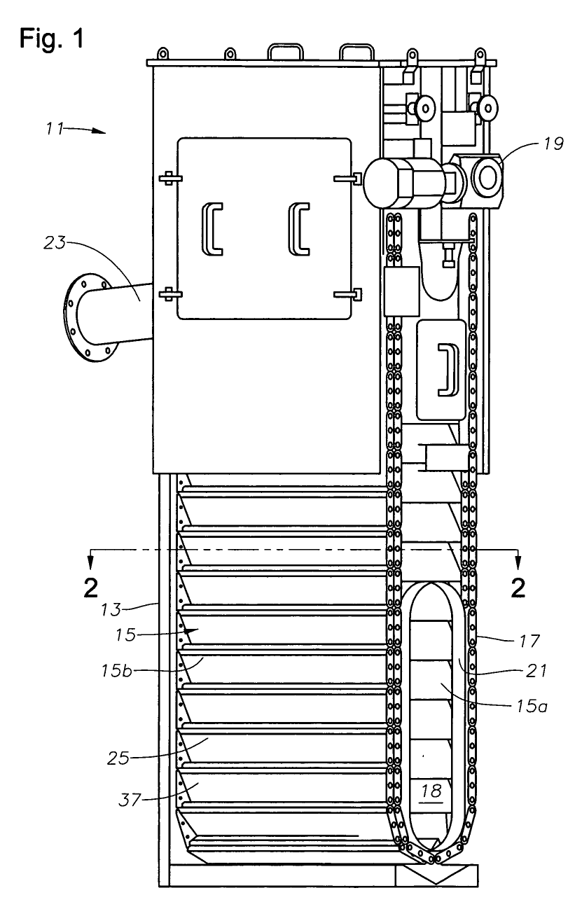

Referring to FIG. 1, center flow perforated plate filter 11 is a large assembly that is typically mounted in a flow channel or box container for filtering wastewater. Filter 11 has a frame 13 that supports a perforated, metal conveyor 15, which rotates in a loop around frame 13. Conveyor 15 has an upward moving run 15a, a downward moving run 15b, and arcuate upper and lower ends between runs 15a, 15b. Chains 17 (only one shown) are located on opposite ends or sides of frame 13 for driving conveyor 15. A drive motor assembly 19, which typically includes a gearbox and an electric motor, provides power to rotate chains 17.

Filter 11 has an upstream inlet 21, which is shown on the right side of FIG. 1. Referring to FIG. 2, the water is diverted into interior 18 of filter 11 between conveyor runs 15a, 15b. The opposite end 24 of frame 13 (FIG. 2) from inlet 21 is closed. This arrangement requires all water in interior 18 to flow outward through either upward moving run 15a or downward moving run 15b to the downstream exterior 26 of filter 11. Debris larger than the perforations of conveyor 15 is conveyed upward to a series of nozzles (not shown) that wash the debris from conveyor 15, causing the debris to flow out discharge chute 23 (FIG. 1). Conveyor runs 15a, 15b receive fluid flow in parallel with the center flow arrangement shown. Alternately, filter 11 could be of a type wherein conveyor runs 15a, 15b receive fluid flow in series, with the water first flowing through run 15a to the interior, and from the interior through run 15b.

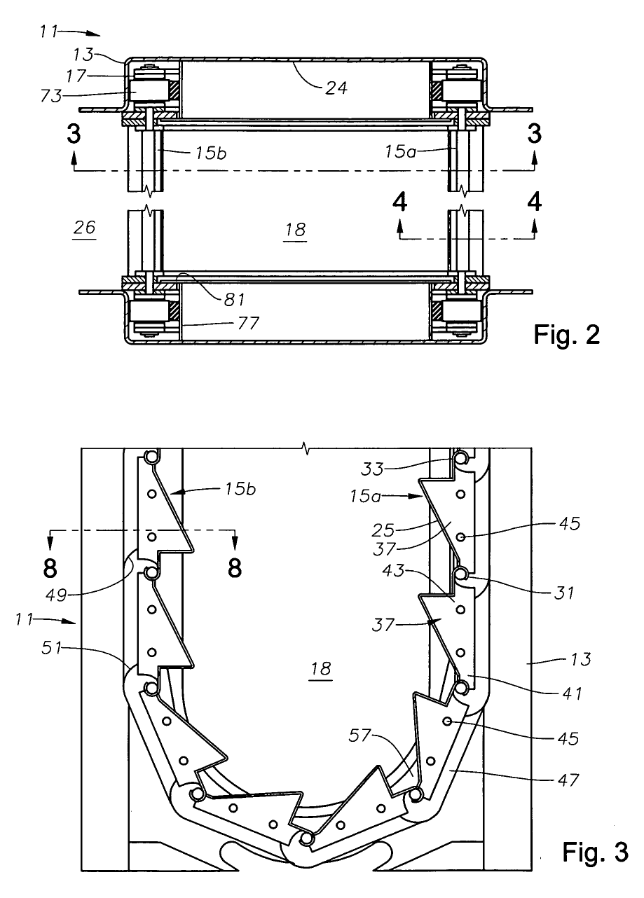

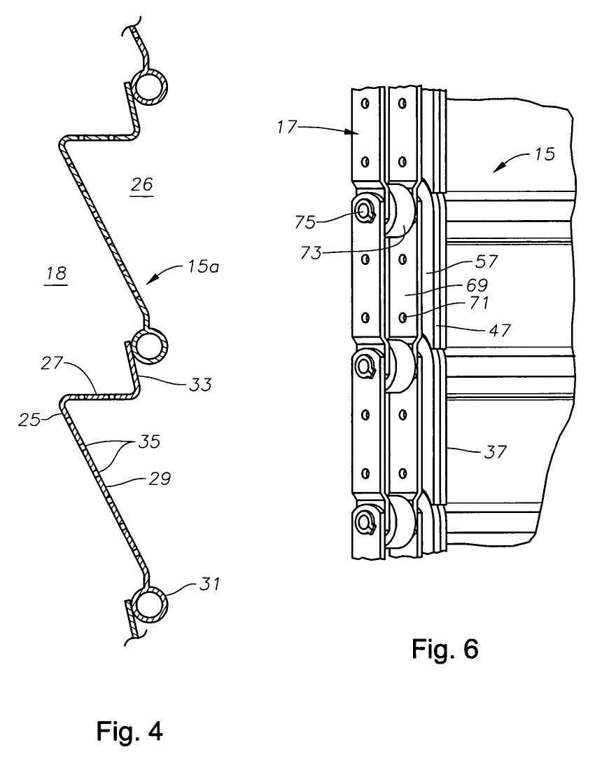

FIG. 4 is a schematic sectional view of a portion of upward moving run 15a. Conveyor 15 is made up of a plurality of screen sections or segments 25. Each screen segment 25 is a separate metallic member from the others and has a generally saw tooth configuration in this embodiment. Each screen segment 25 has a lifting shelf 27 that faces upward and is generally horizontal while in the upward moving run 15a. While in the downward moving run 15b (FIG. 3), lifting shelf 27 will be inverted. A ramp section 29 extends from lifting shelf 27 and terminates in a toe section 31 in this embodiment. Alternately, each screen segment 25 could be flat, generally in a plane parallel with a plane passing through chains 17. In that instance, shelf 27 would comprise a lip protruding from the flat portion of screen segment 25.

Toe section 31 is preferably a cylindrical or otherwise curved member that is welded to ramp section 29. Toe section 31 is shown to be a hollow tube, but it could alternately be solid. A heel section 33 extends in the opposite direction from lifting shelf 27. Heel section 33 is generally flat and originally at an angle of about 90 degrees relative to lifting section 27, which is perpendicular to the run of chain 17 (FIG. 1). When screen segments 25 are assembled, each heel section 33 contacts toe section 31 of the adjacent screen segment 25 and deflects inwardly toward filter interior 18. The deflection is elastic, not permanent, and creates a metal-to-metal seal to prevent debris from bypassing conveyor 15. The stiffness and resilience of heel section 33 causes a bias force to be exerted against toe section 31. Also, heel section 33 overlaps and engages the upstream side of toe section 31, so the pressure of flowing fluid exerts additional force against toe section 31. Heel section 33 and toe section 31 rotate relative to each other in sliding contact while in the arcuate upper or lower ends of conveyor 15 (FIG. 3). Also, heel section 33 and toe section 31 are able to move linearly, parallel with runs 15a, 15b a small amount to accommodate stretching of chains 17.

Each screen segment 25 has a plurality of perforations 35 within ramp section 29 and lifting shelf 27. Perforations 35 comprise circular holes formed in the metal plate making up each screen segment 25. Alternatively, each screen segment 25 could be formed of a mesh material, and the spaces between the wires making up the segment would comprise the perforations of apertures.

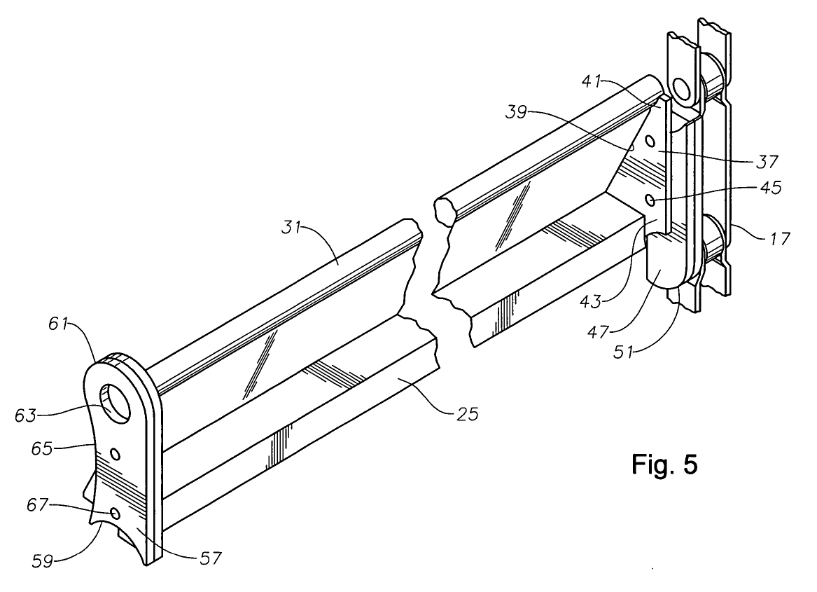

Referring to FIGS. 3 and 5, an end plate 37 is attached to each end of each screen segment 25, preferably by tack welding. FIG. 5 is a view of the exterior side of one of the screen segments 25. End plate 37 has the same general configuration as one of the screen segments 25. Each end plate 37 has a ramp section 39 that parallels or is flush with screen segment ramp section 29 (FIG. 4). Each end plate 37 also has a toe section 41 and a heel section 43. Heel section 43 is not welded to heel section 33 (FIG. 4) of screen segment 25 because flexibility is desired in heel section 33. Toe section 41 of end plate 37 may be welded to toe section 31 (FIG. 4) of each screen segment 25. End plates 37 are used to secure each screen segment 25 to chains 17 independently of the other screen segments 25. Fastener holes 45 provided in end plate 37 are used for the purpose of fastening end plates 37 to chains 17.

Referring to FIGS. 5-7, a first seal member 47 mounts with one side in abutment with each end plate 37. First seal member 47 is preferably formed of a thermoplastic material, such as UHMW material, but it could be formed of metal. First seal member 47 has a concave toe section 49 and a convex heel section 51. First seal member 47 has a straight inner edge 53 that faces toward the opposite conveyor run 15a or 15b (FIG. 3). First seal member 47 has fastener holes 55 that align with fastener holes 45 in end plate 37. First seal member 47 has an outer edge that is parallel to inner edge 53 in this embodiment.

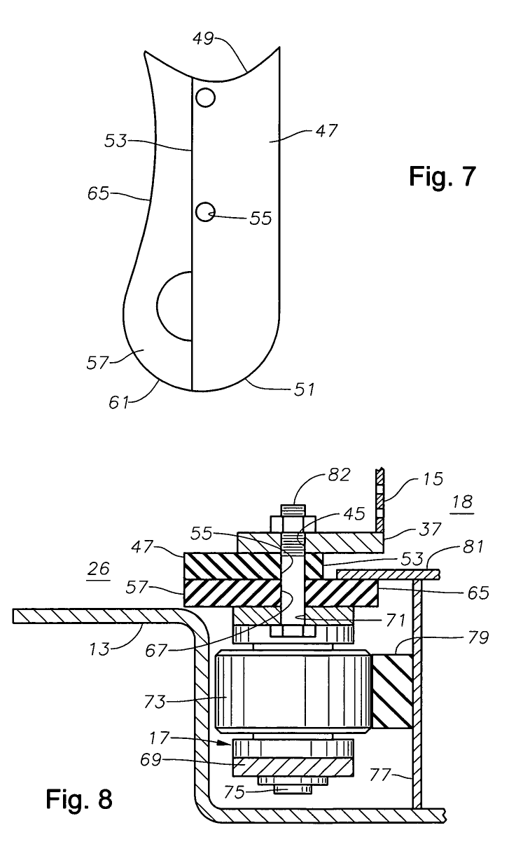

A second seal member 57 locates with one side in abutment with first seal member 47 and a second side connected to chain 17 (FIG. 6). Alternately, the positions of first seal member 47 and second seal member 57 could be reversed. Second seal member 57 is located on the side of first seal member 47 opposite end plate 37. Second seal member 57 is preferably of the same material as first seal member 47 and could be integrally formed with it if desired. Second seal member 57 has a concave toe section 59 that is flush with concave toe section 49 of first seal member 47. Second seal member 57 has a convex heel section 61 that is flush with convex heel section 51 of first seal member 47. Second seal member 57 is wider than first seal member 47 and has an inner edge 65 that faces the opposite conveyor run 15a or 15b (FIG. 3). Edge 65 of second seal member 57 is curved with a large radius. Second seal member 57 has a large clearance hole 63 concentric with its convex heel section 61. As shown in FIG. 5, fastener holes 67 are located in second seal member 57 to align with fastener holes 55 (FIG. 7) and 45 (FIG. 5). When secured together, each seal members 47 and 57 may be considered to be a single seal member having a thicker outer portion, which comprises both seal members 47, 57, than inner portion, which comprises on seal member 57. Inner edge 53 may be considered to be a shoulder or ledge.

Referring to FIG. 6, chain 17 is made up of a plurality of links 69, each being a flat plate. Links 69 have fastener holes 71 that align with fastener holes 55 (FIG. 7), 67 (FIG. 5) and 45 (FIG. 5). Second seal member 57 has one side in flat abutment with one of the links 69. Chain 17 has rollers 73 that are mounted between links 69 by axles or pins 75. Clearance hole 63 (FIG. 7) provides access for the head or the retainer of pin 75.

FIG. 8 is an enlarged horizontal sectional view of one run of one of the chains 17 and associated components. FIG. 8 is also an enlargement of the lower left portion of FIG. 2. Frame 13 has a track frame member 77 that extends inward toward filter interior 18, defining three sides of a cavity or compartment for each chain 17. A track 79 of a plastic or metal material is mounted within the cavity to frame member 77. Roller 73 is free to roll on track 79. Frame 13 has an interior frame panel 81 that joins and is perpendicular to track frame member 77. Interior frame panel 81 separates filter interior 18 from the exterior 26 of filter 11, except for inlet 21 (FIG. 2). The smaller width of first seal 47 accommodates interior frame panel 81. Inner edge 53 is spaced from frame panel 81.

Frame member 18 is closely spaced to the inner side of seal member 57 and spaced a little farther from end plate 37. The convex portion of edge 65 of second seal member 57, where it extends around aperture 63 (FIG. 7) is closely spaced or could slide against track frame member 77. The various narrow paths between frame panel 81 and end plate 37, between frame panel 81 and seal member 57, and between part of edge 65 and track frame member 77 define a serpentine passage to retard the entry of debris into the chain compartments. Fluid tight seals between interior 18 and the chain compartments are not required, but the serpentine passages should be sufficiently narrow to block debris contained in the waste water.

Fasteners 82 extends through the respective holes 71, 67, 55 and 45 to secure screen segments 25 (FIG. 50 and seal members 47, 57 (FIG. 7) to chains 17 (FIG. 6). Alternately, fasteners 82 could be eliminated and chain pins 75 (FIG. 6) used to fasten each screen segment 25 to chain 17. If so, pins 75 could be attached to the ends of each toe section 31 (FIG. 4) and extend outward through the central hole in each chain roller 73 (FIG. 8).

In operation, referring to FIG. 1, motor assembly 19 drives chains 17, causing conveyor 15 to rotate. Water enters inlet 21 into filter interior 18 and discharges through upward moving conveyor run 15a and downward moving conveyor run 15b, as illustrated in FIG. 2. The water flows through perforations 35 in screen segments 25 (FIG. 4), and debris larger than perforations 35 is trapped within filter interior 18. Because of the pressure drop as the water flows through perforations 35, a higher pressure will exist on the inside 18 of filter 11 than in the downstream area 26. Referring to FIG. 8, the water of the downstream area 26 is free to enter the cavity surrounding each chain 17, but this water should be substantially free of debris, which is trapped in interior 18. The trapped debris is sealed from entry into the cavities containing chains 17 by means of the engagement of edge 65 of second seal member 57 with track frame member 77. Furthermore, the small clearance between interior frame panel 81 and the inward facing side of second seal 57 retards the entry of debris into contact with chain 17, because it defines a serpentine flow path.

Referring to FIG. 4, the adjacent edges of screen segments 25 are sealed by the sealing engagement of heel section 33 and adjacent toe section 31. The pressure difference between interior area 18 and downstream exterior area 26 tends to increase the sealing contact by urging the flexible heel sections 33 against the toe sections 31. The trapped debris in interior 18 is lifted by lifting shelves 27, washed from conveyor 15, and discharged out chute 23 (FIG. 1).

Screen segments 25 are not directly fastened to each other, rather each is individually fastened to a link 69 (FIG. 6) of chain 17. Over time, chains 17 will stretch. This causes screen segments 25 (FIG. 4) to move slightly further apart from each other. However, heel sections 33 are sized to have an extra length to accommodate stretching of chain 17 and still maintain a seal with toe sections 31. Heel sections 33 maintain sealing engagement with toe sections 31 by rotating relative to each other as they pass over the arcuate upper and lower ends of conveyor runs 15a, 15b.

The invention has significant advantages. The engagement of the edges of the conveyor segments with each other prevents leakage of debris between the segments. The engagement of the edges allows some linear movement between the edges to occur due to the chain stretching. The seal plates effectively prevent leakage of debris into the areas containing the chains.

While the invention has been shown in only one of its forms, it should be apparent to those skilled in the art that it is not so limited but is susceptible to various changes without departing from the scope of the invention.

1. A filter, comprising:
a frame;
a pair of driven chains carried by the frame and extending in a loop;
a plurality of segments located between and secured to the chains for movement in unison, each of the segments having apertures for the passage of fluid and for trapping debris; and
each of the segments having first and second edges, wherein the first edge of each of the segments overlies and is biased against the second edge of an adjacent one of the segments.

2. The filter according to claim 1, wherein the first edge is substantially flat and the second edge has is curved.

3. The filter according to claim 1, further comprising:
an end plate mounted to each end of each of the segments; and
at least one fastener extending between each of the end plates and a link of the chain for connecting the segments to the chain.

4. The filter according to claim 1, further comprising:
a pair of end plates mounted on opposite ends of each of the segments;
the second edge of each of the segments being rigidly secured to one of the pairs of end plates; wherein
the first edge of each of the segments is movable a small amount relative to the pairs of end plates; and
the first edge is stiff and resilient to cause the bias of the first edge against the second edge of an adjacent one of the segments.

5. The filter according to claim, further comprising:
seal plates located between the chains and ends of the segments and movable in unison with the chains;
the chains are located within chain cavities of the frame; and
wherein the seal plates and the frame define serpentine flow paths to the lateral cavities to retard the entry of debris into the chain cavities.

6. The filter according to claim 1, further comprising:
a pair of end plates mounted on opposite ends of each of the segments;
a plurality of seal plates, each of the seal plates being secured between a link of one of the chains and one of the end plates; and
each of the seal plates having a convex end and a concave end, the convex and concave ends of adjacent ones of the seal plates slidingly engaging each other.

7. The filter according to claim 1, wherein:
each of the segments has a ramp extending from its shelf to one of its edges; and
each of the end plates has an edge portion that is flush with the shelf and an edge portion that is flush with the ramp of its segment.

8. The filter according to claim 1, wherein the first edge of each of the segments engages an upstream side of the second edge the adjacent one of the segments.

9. The filter according to claim 1, wherein the first edge leads the second edge, considering the direction of rotation of the chains.

10. A filter, comprising:
a frame;
a pair of driven chains carried by the frame and extending in a loop;
a plurality of segments located between the chains, each of the segments having apertures for the passage of fluid and for trapping debris;
a pair of end plates secured to opposite ends of each of the segments;
a plurality of thermoplastic seal plates, each of the seal plates being located between one of the end plates and a link of one of the chains;
at least one fastener extending through an aligned hole in each of the end plates, each of the seal plates, and one of the links to secure the segments to the chain for movement therewith; and
each of the segments having a first edge and a second edge, wherein the first edge of each of the segments overlaps an upstream side of and slidingly engages a second edge of an adjacent one of the segments, the first and second edges of adjacent ones of the segments being linearly movable a small amount relative to each other.

11. The filter according to claim 10, wherein the first edge is resilient, stiff and free of direct connection to the pair of end plates.

12. The filter according to claim 10, wherein:
the chains are located within chain cavities of the frame; and
wherein the seal plates and the frame define serpentine flow paths to the lateral cavities to retard the entry of debris into the chain cavities.

13. The filter according to claim 10, wherein each of the seal plates comprises:
an inner portion and an outer portion, the inner portion having a greater thickness than the outer portion, defining a straight ledge that extends from a first edge to a second edge of each of the seal plates, the ledge being parallel to a run of each of the chains.

14. The filter according to claim 10, wherein one of the edges is substantially flat and the other of the edges is curved.

15. The filter according to claim 10, wherein one of the edges is substantially flat and the other of the edges has a cylindrical exterior.

16. The filter according to claim 10, wherein:
each of the segments has a shelf for lifting debris and a ramp extending from its shelf to one of its edges; and
each of the end plates has an edge portion that is flush with the shelf and an edge portion that is flush with the ramp of its segment.

17. The filter according to claim 10, wherein the first edge leads the second edge, considering the direction of rotation of the chains.

18. A method of filtering a liquid, comprising:
(a) mounting a pair of chains to frame and extending in a loop;
(b) securing perforated segments between and to the chains with a first edge of each of the segments overlying and biased against a second edge of an adjacent one of the segments, each of the segments having a shelf;
(c) driving the chains to rotate the segments around the loop; and
(d) flowing the liquid through each of the segments, trapping debris in the liquid with the segments.

19. The method according to claim 18, wherein step (d) comprises exerting a pressure by the flowing liquid on each of the first edges, the pressure being reacted by each of the second edges.

20. The method according to claim 18, wherein:
step (a) comprises positioning the chains within chain compartments formed in the frame;
step (b) comprises placing seal plates between ends of the segments and the chains for movement with the chains; and
step (d) comprises causing with the seals and the frame liquid to flow through a serpentine flow path from an interior of the frame to the chain compartments.
